(19) United States
(12) Patent Application Publication
(10) Pub. No.: US 2024/0273835 A1
(43) Pub. Date: Aug. 15, 2024

(54) COMMUNICATION DEVICES, ADAPTING ENTITY AND METHODS FOR AUGMENTED/MIXED REALITY COMMUNICATION

(71) Applicant: Telefonaktiebolaget LM Ericsson (publ), Stockholm (SE)

(72) Inventors: Harald GUSTAFSSON, Lund (SE); Héctor CALTENCO, Oxie (SE); Andreas KRISTENSSON, Södra Sandby (SE)

(21) Appl. No.: 18/561,175

(22) PCT Filed: May 19, 2021
(86) PCT No.: PCT/EP2021/063363

§ 371 Date: Nov. 15, 2023

(51) Int. Cl. G06T 19/00; G06F 3/01; G06T 13/40; H04L 67/131

(52) U.S. Cl. CPC G06T 19/006; G06F 3/011; G06T 13/40; G06T 2210/56; G06T 2219/024; H04L 67/131

(57) ABSTRACT

Methods and apparatus are provided for adaptation between different environments in Augmented Reality or Mixed Reality (AR/MR) communication in an AR/MR system. The AR/MR system includes at least two communication devices such as a first and a second communication device. The first and second communication devices are in their respective physical environments and are associated with their respective users. The spatial and semantic characteristics of both the user and the physical environments are captured in order to adapt to the virtue representations of the users to each other's context, while still keep the focus of the conversation towards users' interaction. The embodiments herein will give a natural, immersive and bi-directional unintrusive communication, as if the other person would be present next to you, without disrupting either person's activity.

### TECHNICAL FIELD

Embodiments herein relate to communication devices, adapting entity and methods for Augmented Reality or Mixed Reality (AR/MR) communication. In particular, they relate to adaptation between different environments in AR/MR.

### BACKGROUND

Augmented Reality (AR) is an interactive experience of a real-world environment where the objects that reside in the real world are enhanced by computer-generated perceptual information. Augmented Reality (AR) can be defined as a real-time direct or indirect view of a physical real-world environment that has been enhanced or augmented by adding virtual computer-generated perceptual information to it. AR communication can be defined as a system that fulfills three basic features: a combination of real and virtual worlds, real-time interaction, and accurate 3D registration of virtual and real objects. The overlaid sensory information can be constructive i.e., additive to the natural environment, or destructive i.e., masking of the natural environment. This experience is seamlessly interwoven with the physical world such that it is perceived as an immersive aspect of the real environment. In this way, augmented reality alters one's ongoing perception of a real-world environment, whereas virtual reality completely replaces the user's real-world environment with a simulated one. Augmented reality is related to two largely synonymous terms: mixed reality and computer-mediated reality. In AR, digital content such as interfaces, media or graphs are typically displayed into the users real-world-view through a transparent screen or wearable video display showing a camera feed and the virtual media. Another definition is Mixed Reality (MR), which defines a very similar but even more advanced integral technology—by mapping virtual interactive objects into the physical world. AR and MR are sometimes used interchangeably.

Augmented reality is used to enhance natural environments or situations and offer perceptually enriched experiences. With the help of advanced AR technologies e.g., adding computer vision, incorporating AR cameras into smartphone applications and object recognition, the information about the surrounding real world of the user becomes interactive and digitally manipulated. Information about the environment and its objects is overlaid on the real world. Augmentation techniques are typically performed in real time and in semantic contexts with environmental elements. Immersive perceptual information is sometimes combined with supplemental information like scores over a live video feed of a sporting event. This combines the benefits of both augmented reality technology and AR communication equipment technology, e.g., heads up display (HUD), or head mounted display (HMD).

AR communication equipment is available today and will be even more usable in public in a few years' time. Features such as improved battery time, decreased weight, increased field of view, increased angular resolution, and improved gesture accuracy are being worked on.

AR communication equipment typically consist of AR glasses with transparent displays, where objects can be displayed overlayed on the environment with a stereoscopic effect. Then also gesture tracking is done for body part movements using accelerometers, gyroscopes, cameras, radio, etc. Some AR glasses or headsets have embedded outside cameras that capture the environment and also may have inner cameras that captures the user's face. Most AR glasses or headsets also have microphones able to capture user's speech. AR communication equipment will continue to develop and be easier to use in a near future, but necessary functionality exists already today.

Nowadays, when you call someone, you can simply tap your wireless headset and tell who you want to call and then you can start an audio conversation hands-free almost as if the other person was next to you. You can continue with other tasks in parallel to the phone call without needing to consider the communication device. For video calls it has seen a development where the device must be held in front of you, causing a step back in usability compared to audio calls. Although, video gives visual additions to the communication not available with audio-only calls such as e.g. facial expressions, non-verbal communication cues, showing parts of the environment to the remote party, etc. Likewise, VR and AR based communication have evolved in recent years. VR-based communication mostly involves having virtual avatars meet in a virtual space, while the user has a head mounted display (HMD) that blocks visual contact with the real world. Performing other tasks in parallel is almost impossible while in a VR communication.

Jo Dongsik, et. al, in “Avatar motion adaptation for AR based 3D tele-conference”, IEEE International Workshop on Collaborative Virtual Environments (3DCVE), 30-30 Mar. 2014, discloses a tele-conference prototype where the motion of the teleported avatar is adapted to the physical configuration of the remote environment where it will be projected. The adaptation is needed due to the differences in the physical environments between two sites where the human controller is interacting at one e.g. sitting on a low chair and the avatar is being displayed at the other e.g. augmented on a high chair. The adaptation technique is based on preserving a particular spatial property among the avatar and its interaction objects between the two sites. The spatial relationship is pre-established between the important joint positions of the user/avatar and carefully selected points on the environment interaction objects. The motions of the user transmitted to the other site are then modified in real time considering the “changed” environment object and by preserving the spatial relationship as much as possible. It does pose-tracking i.e., skeletal-tracking using external cameras e.g., Kinect-based human tracking and adapts/re-maps the tracked pose to one more fitting to the remote environment. However, it focuses mostly on adapting the tracked pose to a more fitting projected pose while sitting on low versus high chair.

Andrei Sherstyuk, et.al. in “Virtual Roommates in multiple shared spaces”, 2011 IEEE International Symposium on VR Innovation, 19-20 March 201, Page 81-88, describes a telepresence application in AR on how virtual roommates can share remote environments and objects, and coexist in loosely coupled environments. Virtual Roommates is a system that employs AR techniques to share people's presence, projected from remote locations. Virtual Roommates is a feature-based mapping between loosely linked spaces. It allows to overlay multiple physical and virtual scenes and populate them with physical or virtual characters. The Virtual Roommates concept provides continuous ambient presence for multiple disparate groups, similar to people sharing living conditions, but without the boundaries of real space. It uses feature-based spatial mapping between linked spaces to first localize the object in its own environment, and then project it to the remote environment for visualization. It re-maps object locations and paths from the own to the remote environment by dismissing linear transformations of user paths from one environment to another, which would require both environments to be similar, if not identical. It uses local features as anchors for localization, which are directly mapped to anchors in the remote environment where the avatar will be projected to. This allowing the path of the projected avatar to move from one anchor to another in the remote environment, based on the identified anchors on the local environment. It can identify the relative location and orientation relative to the local anchors and translate that relative to the remote anchors for projection. It requires a direct correspondence between local and remote anchors to be in place. Therefore, it requires some mapping between the remote and local environments to be done beforehand.

### SUMMARY

As part of developing embodiments herein some problems are identified and will first be discussed.

AR-based communication has adapted a User Experience (UX) model with a static “hologram” in front of you representing the remote party that one is used to from science fiction movies. This gives an unnatural interaction that limits other activities in parallel. Other AR communication platforms, such as spatial.io, allow one to share virtual content and be represented as virtual avatars within a local real environment in the background. The user is able to move and interact with the local real environment, while interacting with remote avatars and shared virtual objects. While this gives more freedom to both remote and local users, bringing both virtual content and avatars into one's environment, it is still not possible to share elements of the local environment with each other and not all facial expressions and non-verbal communication are expressed through avatars, since it is made to mostly capture hand movement in the field of view. Moreover, it still limits the interaction with the local environment within a single room since the location of virtual objects and avatars is anchored to the mapped space of the single room.

Existing solutions for AR communication allow different parties to interact with each other's avatars and to share virtual content with each other, projecting both avatars and virtual shared content, to their current local environment. They do so by creating a shared virtual environment and re-mapping the location of the objects and avatars in the virtual environment to anchored locations of each of the participant's local environments. These types of solutions are agnostic to each of the participant's environments other than for the purpose to anchor virtual objects in specific locations and do not capture participants' gestures or facial expressions other than hand gestures for input and object interaction commands, nor allow to share real objects or elements of the environment. These solutions are more suited for conference room meetings where virtual content is the focus of the conversation.

On the other hand, holographic calls use holoportation concept to transfer point cloud 3D captures of participants to be compressed, transported and reconstructed on the other side. These types of technologies require fixed external calibrated cameras to capture high quality 3D models. These solutions are made for confined non-mobile environments and are also more suited for conference room meetings or recording rooms where the participant is the focus.

Therefore, there are potentials of improving the usability and experience of users with AR/MR-based communication. Embodiment herein provide communication devices, adapting entity and methods for allowing a more natural AR/MR communication.

According to one aspect of embodiments herein, the object is achieved by an adapting entity and method therein for adaptation between different environments in Augmented Reality or Mixed Reality (AR/MR) communication in an AR/MR system. The AR/MR system comprises at least two, a first and a second communication devices. The first and second communication devices are in their respective physical environments and are associated with their respective users.

The adapting entity obtains a virtual representation of the user of the first communication device. The virtual representation comprises information on gestures and/or facial expressions of the user of the first communication device.

The adapting entity obtains spatial and semantic characteristics data of the physical environment and user of the second communication device from the second communication device.

The adapting entity generates an adapted virtual representation of the user of the first communication device by adapting the virtual representation of the user of the first communication device based on the spatial and semantic characteristics data of the physical environment and user of the second communication device.

The adapting entity provides the adapted virtual representation to the second communication device for displaying in the physical environment of the second communication device using AR/MR technology.

According to one aspect of embodiments herein, the object is achieved by a first communication device and method therein for adaptation between different environments in Augmented Reality or Mixed Reality (AR/MR) communication in an AR/MR system. The AR/MR system comprises at least two, the first and a second communication devices.

The first and second communication devices are in their respective physical environments and are associated with their respective users.

The first communication device obtains a model representing a user of the first communication device (110).

The first communication device establishes gestures data and/or facial expressions data of the user of the first communication device.

The first communication device generates a virtual representation of the user of the first communication device based on the model and the gestures and/or facial expressions data of the user of the first communication device.

The first communication device provides the virtual representation of the user of the first communication device to an adapting entity for adapting the virtual representation of the user of the first communication device based on spatial and semantic characteristics data of the physical environment and user of the second communication device.

According to one aspect of embodiments herein, the object is achieved by a second communication device and method therein for adaptation between different environments in Augmented Reality or Mixed Reality (AR/MR) communication in an AR/MR system. The AR/MR system comprises at least two, a first and the second communication devices. The first and second communication devices are in their respective physical environments and are associated with their respective users.

The second communication device establishes spatial and semantic characteristics data of the physical environment and user of the second communication device.

The second communication device provides the spatial and semantic characteristics data to an adapting entity for adapting a virtual representation of the user of the first communication device based on the spatial and semantic characteristics data of the physical environment and user of the second communication device. The virtual representation comprises information on gestures and/or facial expressions of the user of the first communication device.

The second communication device obtains from the adapting entity an adapted virtual representation of a user of the first communication device.

The second communication device causes the adapted virtual representation of the user of the first communication device to be displayed in the physical environment of the second communication device using AR/MR technology.

In other words, the solutions according to embodiments herein combine different elements of the avatar-based and capture-based solutions. It is avatar-based in the sense that it does not require external-sensors or cameras for 3D capture of users since the virtual representation of the user is generated by combining the model representing the user and the gestures data and/or facial expressions data of the user. However, it is environment-aware in the sense that it can use in-facing and out-facing cameras in the communication device to capture and understand the spatial and semantic characteristics of both the user and the physical environments in order to adapt to the local context, while still keep the focus of the conversation towards users' interaction. The embodiments herein will give a natural, immersive and bi-directional unintrusive communication, as if the other person would be present next to you, without disrupting either person's activity.

The embodiments herein enable adaptation of an avatar behavior to the local behavior where it will be projected, e.g., sitting vs walking or vs standing, etc. and use environmental understanding to generate paths so that the avatar does not collide with obstacles, and can handle occlusion. Moreover, the embodiments herein can use the teleported participant's AR-headset in-facing cameras to capture gestures and facial expressions and the local participant's AR-headset out-facing cameras to recognize and understand the environment where the avatar will be projected to.

The embodiments herein link the own participant actions to the remote participant's behavior instead of linking remote and local environments together. The embodiments herein enable transmitting facial and upper-body gestures while allowing the projected avatar to “walk with you” or “sit next to you”.

The embodiments herein recognize the environment where the avatar will be projected in order to avoid obstacles, regardless of what the real participant is doing. There is no need to “link” the anchors on the remote and local environments according to embodiments herein. The embodiments herein need real time context detection in order to adapt the projected avatar to behave accordingly.

The embodiments herein are based on that the tele-ported avatar or virtual representation of a user's position and/or motion are modelled and adapted based on the other user's behavior beyond just an adaptation to the environment. The embodiments herein have advantages than the existing prior art by deriving a new motion/position not just an altered version, i.e. the adaption according to embodiments herein is not only a transform but also a replacement of the model.

Therefore, embodiments herein provide an improved method and apparatus for adaptation between different environments in AR/MR communication.

### BRIEF DESCRIPTION OF THE DRAWINGS

Examples of embodiments herein are described in more detail with reference to attached drawings in which:

FIG. 1 is a schematic block diagram depicting an AR/MR system;

FIG. 2 is a signal flow chart illustrating example actions for AR communication in the AR/MR system according to embodiments herein;

FIG. 3 shows examples for a) egocentric pose capture from fisheye camera and b) hand gesture capture from four wide-angle tracking cameras;

FIG. 4 shows examples for mapping facial expression from user to virtual avatar using photo-reflective sensors inside the HMD;

FIG. 5 is a flow chart illustrating a method performed in a first communication device according to embodiments herein;

FIG. 6 is a flow chart illustrating a method performed in a second communication device according to embodiments herein;

FIG. 7 is a flow chart illustrating a method performed in an adapting entity according to embodiments herein;

FIG. 8 is a schematic block diagram illustrating a communication device; and

FIG. 9 is a schematic block diagram illustrating an adapting entity.

### DETAILED DESCRIPTION

As a part of developing embodiments herein some problems or limitations associated with the existing solutions will be further identified and discussed.

Bringing the voice of other to you, no matter where you are and what you are doing, is done today with regular audio calls using a headset. Video calls, to some extent, support this in a fixed environment or sometimes mobile while holding the device in front of you. Bringing other people or objects to your environment can increase the immersiveness of the communication. AR has the potential to more immersively bring others to your environment as well as bringing other objects or elements of the remote environment to each other using head mounted displays (HMDs). However, as discussed above, the existing solutions for AR communication are more suited for conference room meetings where virtual content is the focus of the conversation or recording rooms where the participant is the focus. These types of solutions are agnostic to each of the participant's environments other than for the purpose to anchor virtual objects in specific locations. These solutions do not capture participants' gestures or facial expressions other than hand gestures for input and object interaction commands, nor allow to share real objects or elements of the environment.

Methods are developed according to embodiments herein for allowing a more natural communication using AR. The principle of the methods is based on the following:
Bring the remote participant into your environment, independent of their activity or if that is not matching your activity. For example, you are walking in a non-confined environment and the other person, i.e. the remote participant, is e.g. sitting in said remote participant's current environment, then an avatar of the remote participant is generated that walks next to you instead of having said remote participant's avatar generated as a sitting avatar. Their facial expressions captured by camera and upper body, such as arm, hand gestures are represented through the avatar but the legs movement are artificially generated. Likewise, for the other person your avatar would be sitting next to or in front of them even though you are currently walking. The inner camera captures facial expressions and other person-facing cameras capture upper body movements and gestures, potentially also your current clothing.
Bring objects from the other participant's environment into your environment as virtual representations/avatars. Detecting when a participant interacts with a third-party person and temporarily creating an avatar of that person using external cameras. This is useful for example when standing in e.g. a cashier line in a shop and then reaching the cashier and interacting with her, this will reduce the need to tell the other part, the remote participant, that you are talking to someone else and said remote participant can follow the conversation and understand that you are busy. One can also detect via gestures when one participant interacts with objects on the environment and bring virtual representations CAD-models of such objects into the conversation. For example, the XR glasses facial camera and environment camera can be used to track what you look at and a detection method is used to detect when you look at a person for some time and the distance to that person. Also, the recorded sound can be used to detect that you communicate with someone else, based on relative sound level in relation to the distance to the other person. It can also be detected that you have a conversation by the talk patterns of you and the other party.
Bring in objects from the other participant's environment into your environment e.g. as point cloud reconstructions. The system could detect some environment objects such as a paper, a grocery, a garment, or a toy captured by at least the mono/stereoscopic environment camera, which has no virtual e.g., CAD model representation. This can then be modeled as either a 3D or 2D-projection object in your environment. This can be detected by that the participant interacts with an object, based on gesture tracking and image object detection.
To allow the user to have natural control over the avatars and rendered objects in his environment. Commonly specific gesture patterns are used much like when interacting with a touchscreen, but embodiments herein enable detecting when you are interacting with the avatar, e.g. by moving the avatar by grabbing the avatar's arm, or waving the hand the avatar will move. Embodiments herein also enable detecting when you are interacting with the physical environment, e.g. when looking at a physical object and stretching for it. This can be done since all gestures and line of sight can be tracked.

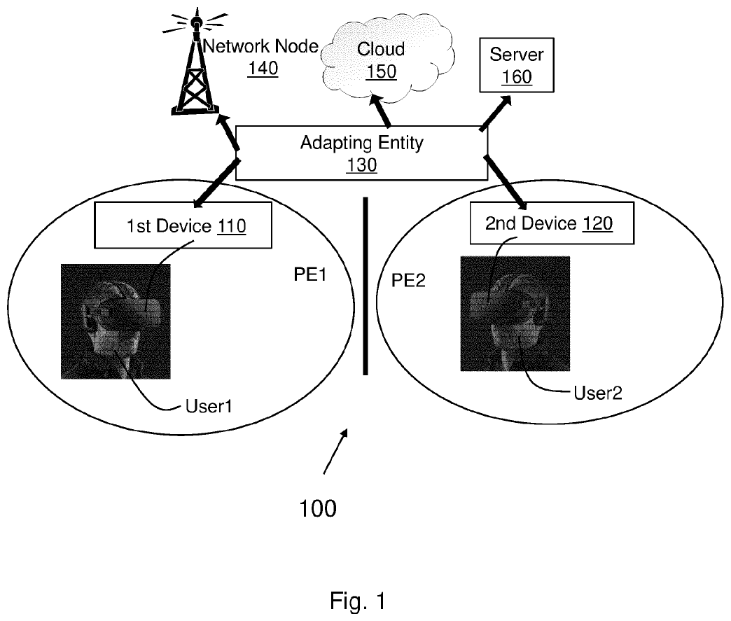

FIG. 1 shows an example of an AR/MR system 100 in which embodiments herein may be implemented. The AR/MR system 100 comprises at least two, a first communication device 110 and a second communication device 120. The first and second communication devices are in their respective physical environments PE1, PE2 and are associated with their respective users User1 and User2. The AR/MR system 100 further comprises an adapting entity 130. The adapting entity 130 may be presented on a network node 140, a cloud 150, a server 160 or one of the two communication devices 110, 120, as indicated by the arrows.

The network node 140 is a network access node which may be a base station (BS), for example, an eNB, gNB, eNodeB, gNodeB, or a Home NodeB, or a Home eNodeB or a Home gNodeB in a wireless communication network. The wireless communication network may be any wireless system or cellular network, such as a second generation (2G) Global System for Mobile Communications (GSM), a third generation (3G) telecommunication network e.g. Universal Mobile Telecommunications System (UMTS), a Fourth Generation (4G) network, e.g. Evolved Packet System (EPS) or Long Term Evolution (LTE) network, a Fifth Generation (5G) New Radio (NR) network, or Wimax network, Wireless Local Area Network (WLAN) or Wi-Fi network etc.

The AR/MR system 100 shown in FIG. 1 is just one example where the communication devices are shown as head mounted devices or glasses and the AR/MR display is a transparent display. The methods according to embodiments herein for a more natural communication may be applied to any AR/MR system with other types of devices and displays. For example, the AR/MR display may be moved from near eye to nearby walls or similar displays. The AR/MR display is not necessarily a transparent display. Transparent display devices are known as Optical-see-through AR devices. While video-displayed AR/MR are known as video-see-through AR. The methods according to embodiments herein may be applied to e.g. mobile phone screens, VR headsets with external capture cameras, wearable video-see-through AR displays etc., since they are also regarded as in an AR system when the real world combined with overlays shows on a screen.

The method according to embodiments herein brings other participants into your environment. Regardless of location and parallel activities from both parties e.g., User1 and User2, one should be able to see a virtual representation, i.e. a holographic representation or an avatar, of the other party(ies) in the conversation. Moreover, the virtual representation of other parties could be adapted to fit into the context and activities in the local environment. That is, if you are walking outdoors, the virtual representation of the remote participant should be able to “walk” next to you even if that person is sitting in his/her sofa. Moreover, it should be able to avoid going through obstacles in the environment. While at the same time, your virtual representation could be sitting on the sofa together with the remote participant, even if you are walking. The adapting entity 130 is for adaption of the virtual representations of the participants User1/User2 between different physical environments i.e., to each other's physical environment PE1/PE2.

The embodiments herein describe the use of AR/MR displays, e.g. AR-HMDs, which enables the layering of 2D or 3D virtual information over a user's view of the world via visual displays. The embodiments herein may be applied to Optical See-Through HMDs (OST-HMDs) which have the capability of reflecting projected images to a transparent material which allows the user to see through it, therefore overlaying projected content on top of the real-world view e.g., Hololens and Magic Leap. The embodiments herein may also be applied to Video See/Pass-Through HMDs (VST-HMDs), which capture the real-world view with video cameras and project both computer-generated content and the video representation of the real world combined in an opaque display e.g., Varjo XR 1. Moreover, the embodiments herein may be applied to standalone HMDs e.g., HoloLens or smartphone-based HMDs e.g., Mira Prism, DreamGlass Air. The embodiments herein rely on the ability that such devices use their onboard sensors to track position and orientation, understand the environment and display overlays.

The following elements in AR/MR displays, e.g. HMDs, are needed or can be used by the embodiments herein:
Front facing cameras: to capture the environment, which can be used to gather spatial and semantic data of the environment, mapping the scene or detecting objects of interest in the environment. These cameras can also be used by SLAM algorithms by themselves or together with other sensors.
Body-facing cameras: to capture body movement and gestures, which may be the same or different from the environment cameras. The cameras should cover more area than the field of view of the user, in order to capture body movement/gestures outside of the field of view. The cameras also could capture the clothing of the user in order to reconstruct the outfit of an avatar or a virtual representation of the user.
Face-facing cameras: to capture face gestures and gaze of the user. These could be used to be able to transmit facial gestures, gaze direction, etc. to the user's avatar, or to interpret facial expressions as emotions and act accordingly.
Inertial Measurement Units (IMUs) in the HMD may also be used to track the position and orientation of the user's head. They can also be used together with environment-facing cameras for Visual-inertial Simultaneous Localization and Mapping (SLAM).
Radio, Global Positioning System (GPS) or other positioning sensors: to provide Geo-positioning information and aid precise localization in indoor and outdoor environment. Combined with visual or visual inertial localization one could get a more robust and precise pose.
OST-display or VST-display are necessary for displaying others' avatars and other virtual objects as overlays.
Spatial audio: to deliver surround sound and 3D audio via headphones.

Managing all the above sensors and inputs for a more natural, immersive and bi-directional unintrusive communication in AR can be very resource demanding. The use of network-supported spatial compute technologies will help offload processing tasks from HMD devices into the network and will allow lightweight AR HMDs to be used for these purposes. In the following, different methods according to embodiments herein for natural AR communication will be described.

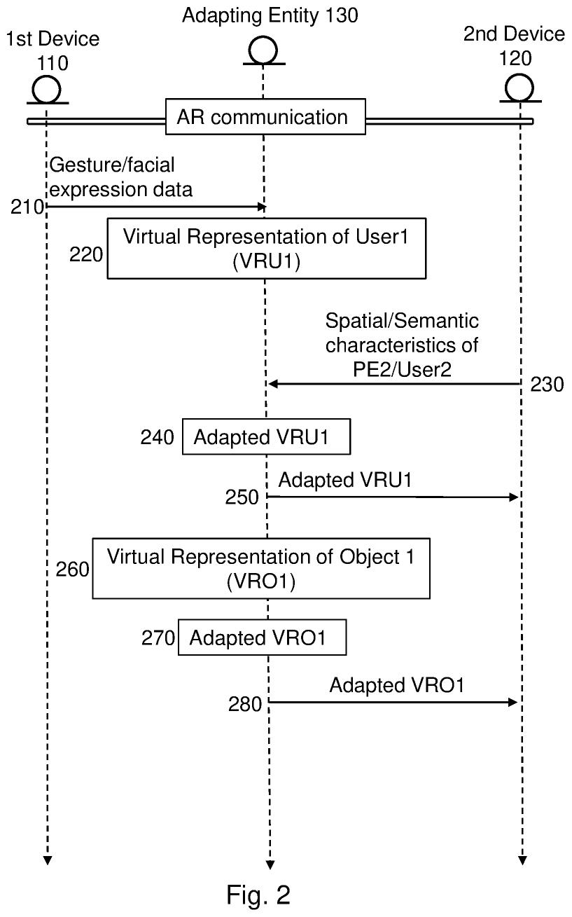

FIG. 2 shows a signal flow chart 200 for AR communication in the AR/MR system 100 according to embodiments herein. The first device 110 associated with the first user User1 and the second device 120 associated with the second user User2 are participating in an AR/XR communication. The first and second devices 110, 120 are in their respective physical environments PE1, PE2. The adapting entity 130 is for adaption of the virtual representations of the participants User1/User2 to each other's physical environment as well as movement, facial and body expressions. The adaption of the virtual representations of the participants is a two-way operation. The signal flow chart only shows steps or actions for adaption of the virtual representation of the first user User1 to the spatial and semantic characteristics of the second physical environment PE2 and second user User2 of the second device 120. The adaption of the virtual representation of the second user User2 to the spatial and semantic characteristics of the first physical environment PE1 and the first user User1 comprises similar actions or steps. The signal flow chart 200 for AR communication comprises the following Actions.

### Action 210

For keeping the facial and body expressions of the participants in sync with each other, gesture and/or facial expressions data of the participants must be captured. An inner camera of the first device 110 may capture facial expressions and other person-facing cameras may capture upper body movements and gestures, potentially also current clothing of the first user User1. The first device 110 provides the captured gesture and/or facial expressions data of User1 to the adapting Entity 130.

### Action 220

The adapting entity 130 obtains a Virtual Representation of the first use User1 of the first communication device 110 (VRU1). The virtual representation of a user comprises information on gestures and/or facial expressions of the user.

The VRU1 may be obtained by obtaining a model representing the user of the first communication device, obtaining gestures data and/or facial expressions data of the user of the first communication device, and then generating the VRU1 based on the model representing the user of the first communication device and the spatial and the gestures data and/or facial expressions data of the user of the first communication device.

The model representing a user may be built or generated as a 3D scan of the user, a textured 3D models or a selection of already available avatars. The AR/MR device or other cameras/infrastructure in the environment may be used to generate/build the model of a user as a 3D scan. Any existing or future methods for building 3D models/avatars of people or creating face texture and 3D-modelling from continuous captured facial video may be used by the embodiments herein and are outside the scope of this application.

With a model representing each conversation participant is available, the upper-body motion of the model can be generated to mimic the motion of the user using body-facing cameras to capture and track motion and gestures of the user. For example, egocentric 3D body pose estimation may be generated from visual data captured from one or more downward looking fish-eye cameras on the HMD, or by other wide-angle tracking cameras. Generally, these gesture and body tracking solutions use machine learning (ML) algorithms to estimate the pose or gesture. Any exiting or future algorithms for predictive posture and hand gesture prediction may be used by the embodiments herein.

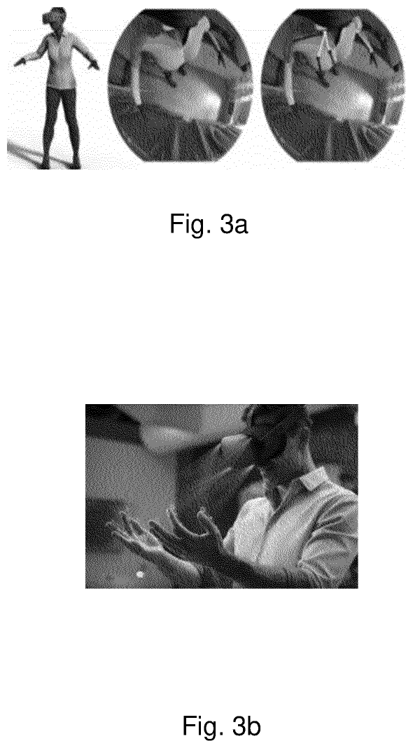

FIG. 3a shows an example for egocentric pose capture from fisheye camera, fromTome, Denis, et al. “xR-EgoPose: Egocentric 3D Human Pose from an HMD Camera”, Proceedings of the IEEE International Conference on Computer Vision. 2019.

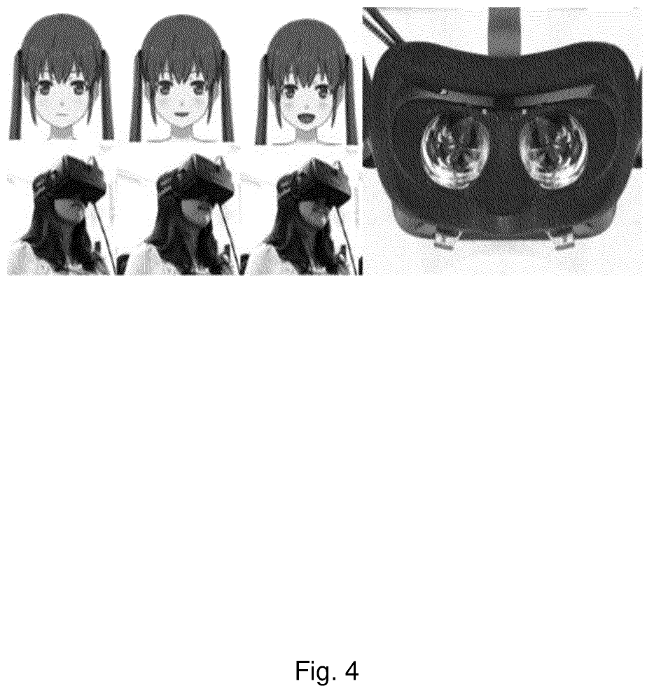

FIG. 3b shows an example for hand gesture capture from four wide-angle tracking cameras of an HMD of Oculus Quest. Face-facing cameras in the HMD can be used, not only to detect gaze direction, but also to detect facial expressions, which may be mapped to the virtual representation of a user to make the experience more immersive. IR gaze-tracking camera can be used to infer a select subset of facial expressions with 70% accuracy. Another way to detect facial expressions is to attach photo-reflective sensors on the inside of the HMD, which measure the reflection intensity between the sensors and the user's face. FIG. 4 shows an example of mapping user's facial expression to a virtual representation using photo-reflective sensors inside the HMD, from Murakami, Masaaki, et al. “AffectiveHMD: facial expression recognition in head mounted display using embedded photo reflective sensors”, ACM SIGGRAPH 2019 Emerging Technologies. 2019. Machine learning techniques have been used to train to detect five facial expression e.g., neutral, happy, angry, surprised, sad. Any exiting or future algorithms and methods for recognizing facial expressions using cameras or photo-reflective sensors can be used by the embodiments herein and are out of the scope of this application.

### Action 230

The second device 120 obtains spatial and semantic characteristics data of the second physical environment PE2 and the second user User2 of the second device 120 and provides it to the adapting entity 130.

The spatial and semantic characteristics of a physical environment may comprise dimensions of a room, placement of furniture etc. in an indoor environment, trees, buildings, streets, cars etc. in an outdoor environment, or any objects, person around the user etc.

The spatial and semantic characteristics of a user comprises any one or a combination of gestures, facial expressions of the user, movement and placement of the user in the user's physical environment etc.

Environment-facing cameras in an HMD can be used to capture the environment and detect the spatial and semantic characteristics of the local environment. The spatial and semantic characteristics data of the physical environment and user is for adapting the remote participant's virtual representation to fit the user's current local context.

### Action 240

The adapting entity 130 generates an adapted virtual representation of the user User1 Adapted VRU1 of the first communication device 110 by adapting the virtual representation of the user of the first communication device 110 based on the spatial and semantic characteristics data of the physical environment PE2 and user User2 of the second communication device 120.

For example, the virtual representation of the User1 is adapted to be sitting next to the User2 even if the User1 is actually standing or working, while the actual real facial expressions and upper body language of the User1 is still mapped to the virtual representation of the User1. When projecting a virtual representation sitting next to someone, it is important to find an available and adequate seat to project it. Projecting the virtual representation in an occupied seat will be unnatural, finding unoccupied seat to project the virtual representation to is necessary for a natural interaction. If no available seat, then the adapting entity 130 may bring a virtual representation of the seat that the User2 is sitting on or generate a virtual seat from an existing 3D model or a copy of one of the existing seats in the environment of the User2.

The User2 interacts with the virtual representation of the User1 that he/she sees in his/her AR/MR glasses, the User2 may be sitting down on the right side of a sofa, waving his hand and looking to the left smiling. The VRU1 should be adapted to this situation based on the spatial and semantic characteristics data of the User2. The VRU1 should be adapted to be sitting on the left side of the User2 on the sofa and looking to the right even if the User1 is sitting on the right side of a sofa and looking to the left or even if the User1 is standing, walking, running in his/her environment.

For another example, when the User2 is walking in his/her environment, the VRU1 should be adapted to be walking next to the User2 even if the User1 is sitting in the sofa or standing in his/her environment. Therefore, even if some aspects of a user, e.g., facial expressions and gestures are mapped to its virtual representation's behavior, other behaviors of the virtual representation, e.g. movement may be artificially generated.

Therefore, according to some embodiments herein, a motion model for the virtual representation of the first user VRU1 may be created based on movement data of the user of the second communication device 120 and the Adapted VRU1 is generated by combining the motion model and the VRU1.

The motion model may be created from generated motion sources mixed with captured or tracked motion or gesture sources of the user of the second communication device 120.

Having a real person walking next to you requires that they interact with the environment in a natural way. A real person will not likely walk through obstacles or walls while keeping a conversation with you. It will feel unnatural if a virtual representation walks through obstacles, floats on air, or behaves unnaturally e.g. contrary to the laws of physics, being unaware of the real environment it is projected on. Environmental with respect to spatial and semantic understanding is therefore necessary to allow the virtual representation interacts with the real environment in a natural way e.g., avoid crashing into other pedestrians or obstacles, climbing stairs, etc. Once having identified the spatial and semantic characteristics of the environment, Human-like autonomous motion planning algorithms may be applied to the virtual representation's movements. While the virtual representation's trajectory may be based on robot motion planning and obstacle avoidance methods applied to the spatial map in combination with goal prediction based on current movement.

Generating path plan for a virtual representation may be based on camera captured environment and find available and adequate elements on the environment to project the virtual representation of a user and object on. If no available elements in the real environment, they may be generated as virtual elements. That is the path plan may be adapted to the spatial and semantic characteristics data of the physical environment of the second communication device 120.

Besides obstacle avoidance, while generating a virtual representation walking movement in a mobile environment, it is important to detect contextual information as part of the semantic analysis of the environment. The semantic analysis may detect what kind of activity one is doing, e.g. playing golf, mowing the lawn, sightseeing, hiking, catching the bus, shopping, etc., and the virtual representation's walking movement should be adapted to those environment based on the detected contextual information.

Environmental understanding also needs to be applied to properly occlude the projected virtual representation when needed, and spatial audio can be applied to map the audio source perception to the location of the virtual representation. Both occlusion handling and spatial audio technologies are out of the scope of this application.

### Action 250

The adapting entity 130 provides the Adapted VRU1 to the second communication device 120 for displaying in the physical environment of the second communication device 120 using AR/MR technology.

According to some embodiments herein, one or more objects may be brought from one participant's environment to other participant's environment as virtual representations. Therefore, the signal flow chart 200 for AR communication may further comprise the following Actions:

### Action 260

The adapting entity 130 may obtain a virtual representation of one or more objects, VRO1, with which the user User1 of the first communication device 110 is interacting in its physical environment.

### Action 270

The adapting entity 130 may generate an adapted virtual representation of the object, Adapted VRO1, by adapting the virtual representation of the object based on the spatial and semantic characteristics data of the physical environment of the second communication device.

### Action 280

The adapting entity 130 may provide the adapted virtual representation of the object, Adapted VRO1, to the second communication device 120 for displaying in the physical environment of the second communication device 120 using AR/MR technology.

According to some embodiments herein, the adapting entity 130 may obtain the virtual representation of the object from the first communication device 110.

According to some embodiments herein, the adapting entity 130 may obtain information on one or more objects with which the user of the first communication device 110 is interacting in its physical environment from the first communication device 110 and generate a virtual representation of the object based on the information on one or more objects with which the user of the first communication device 110 is interacting.

In the following, methods according to embodiments herein for AR/MR communication in the AR/MR system 100 will be described with respect to the first and second communication devices 110, 120 and the adapting entity 130.

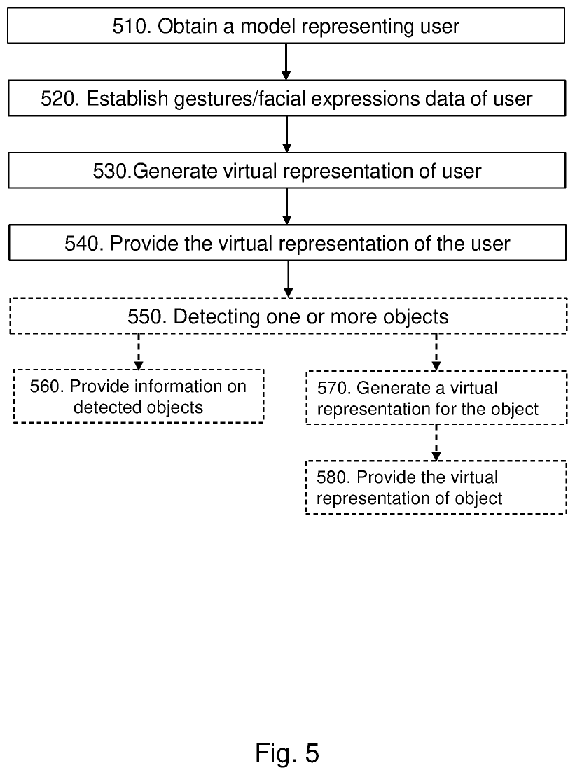

FIG. 5 shows a flow chart for a method performed in a first communication device 110 for adaptation between different environments in AR/MR communication in the AR/MR system 100. The AR/MR system 100 comprises at least two, the first and a second communication devices 110, 120. The first and second communication devices 110, 120 are in their respective physical environments PE1, PE2 and are associated with their respective users, User1, User2. The method comprises the following actions.

### Action 510

The first communication device 110 obtains a model representing the user of the first communication device 110.

The model representing a user may be built or generated as a 3D scan of the user, a textured 3D models or a selection of already available avatars. The cameras in the first communication device 110 or other cameras or infrastructure in the environment may be used to provide 3D scan of the user.

The first communication device 110 may create the model from a captured snapshot of user's body, or 3D scans of the user, either by own camera in the first communication device 110 or other cameras or infrastructure in the environment.

The first communication device 110 may build the model using available CAD textured models of a person, or by mapping an available CAD model with characteristics of the user, such as clothes, hair style etc.

Any exiting or future methods for building 3D models/avatars of people may be used by the first communication device 110.

### Action 520

The first communication device 110 establishes gestures data and/or facial expressions data of the user of the first communication device. As discussed above in Actions 210, 220 with reference to the signal flow chart 200, any existing or future algorithms and methods for recognizing facial expressions and gestures can be used by the first communication device 110.

### Action 530

The first communication device 110 generates a virtual representation of the user of the first communication device 110 based on the model and the gestures and/or facial expressions data of the user of the first communication device 110. The virtual representation comprises information on gestures and facial expressions of the first user User1.

### Action 540

The first communication device 110 provides the virtual representation of the user of the first communication device 110 to the adapting entity 130 for adapting the virtual representation of the user of the first communication device 110 based on spatial and semantic characteristics data of the physical environment PE2 and user User2 of the second communication device 120. The adaption of the virtual representation may vary depends on different situations which has been described above in Action 240 with reference to the signal flow chart 200.

According to some embodiments herein, the adapting entity 130 may be a part of the first communication device 110, i.e., an entity in the first communication device 110 or an entity in a network node 140, a server 160, a cloud 150 or the second communication device 120. The term “provides” or “providing” may mean that something is transmitted from an entity to another entity internally within a device or something is transmitted from an entity in a device to an external entity.

To bring one or more objects from the environment of the first communication device 110 to the environment of the second communication device 120 as virtual representations, the first communication device 110 may further perform the following actions:

### Action 550

The first communication device 110 detects one or more objects with which the user of the first communication device 110 is interacting in its physical environment based on any one or a combination of gesture tracking, image object detection, the user's and/or other's speech.

The objects of interest and other objects or persons the user interacts with may be detected using object detection methods. Identifying and locating such objects or persons in 3D space or relative to the user's pose is necessary in order to recognize which class, shape and orientation of detected objects of interest.

Once the class, shape and orientation of detected objects of interest have been identified, a 3D model of objects and persons may be built in multiple ways, e.g. 3D reconstructions, existing CAD models textured with RGB information from the device sensors, artificially generated objects based on existing CAD models and available image of the object e.g., using generative adversarial network (GANs), or simply using existing CAD models of such objects and people and reorienting them based on their spatial orientation.

Besides content analytics from the environment cameras to detect persons or objects of interest, sensory data of the body-facing and face-facing cameras may be analyzed to detect user interaction intents with such objects. It is possible to infer interactivity with other people and objects from gaze patterns and gestures. Changes on the tone of voice may also be helpful to detect interaction patterns aimed at others.

After the one or more objects have been detected by the first communication device 110, virtual representations of the one or more objects may be generated either by the first communication device 110 or by the adapting entity 130. The method may further comprise the following actions:

### Action 560

The first communication device 110 provides information on the detected one or more objects to the adapting entity 130 for generating a virtual representation of the one or more objects and adapting the virtual representation of the object based on spatial and semantic characteristics data of the physical environment and user of the second communication device 120.

### Action 570

The first communication device 110 generates a virtual representation for the object with which the user of the first communication device is interacting.

The virtual representation of the one or more objects may be generated by using available models for the recognized objects or generating 3D or 2D models for the objects using point cloud reconstructions or combining the available models with point cloud reconstructions.

### Action 580

The first communication device 110 provides the virtual representation of the object to the adapting entity 130 for adapting the virtual representation of the object based on spatial and semantic characteristics data of the physical environment and user of the second communication device 120.

Similar to bringing a virtual representation of a remote participant to interact in a natural way with the local environment, other person or objects should also be able to be brought into the conversation in a natural manner. For example, when bringing a coffee cup, having the coffee cup floating in the air while resting would seem unnatural. The system could find an appropriate surface to place the projection of the cup or bring or generate a virtual representation of a table to place it there.

When trying to bring objects that have not been identified or that an existing 3D model is not available, or to bring specific details of a real object that cannot be texturized or represented correctly with existing models, an image, scan or 3d capture of such object is needed.

A precise 3D scan of the object from multiple angles might be preferable way to bring a 3D dense and texturized point cloud representation of the object. In which case, instructions to the user, e.g. the user of the first communication device 110, may be generated on the device, such as “place the object standing still”, “walk around the object” etc., to perform a 3D scan in order to obtain a virtual model of such object. There are multiple methods like multi-view-stereo (MVS) and structure-from-motion (SfM) to perform these scans. Any existing and future 3D scanning methods and technologies may be used and are out of the scope of this application.

Alternatively, bringing a captured object to the environment without having to stop to scan it, that is within the same session. One may use visual or visual-inertial simultaneous localization and mapping (SLAM) methods to “update” the model little by little when more feature of the object has been detected.

If depth sensors e.g., stereo-cameras, IR-scanning cameras, light detection and ranging or laser imaging, detection and ranging (Lidars) etc. are available from the device, a more precise and faster dense representation of the object can be generated, in combination with specific SLAM methods e.g., lidar-based SLAM, one could also update the model gradually when more views, features, angles have been captured. The SLAM algorithms for gradually building the 3D model of the object are out of the scope of this application.

Extracting CAD type models from the 3D model is the most challenging step. The current option is to use professional tools e.g., Geomagic Studio. The stability of this process is greatly increased if the visual object detector recognizes the essential components of the object. Recognized parts of the 3D model may be directly replaced by an accurate 3D model e.g., provided by the manufacturer. Visual object detectors e.g., convolutional neural networks, specifically trained to detect such object elements may be needed for this. Extraction of CAD models from captured 3D models are out of the scope of this application.

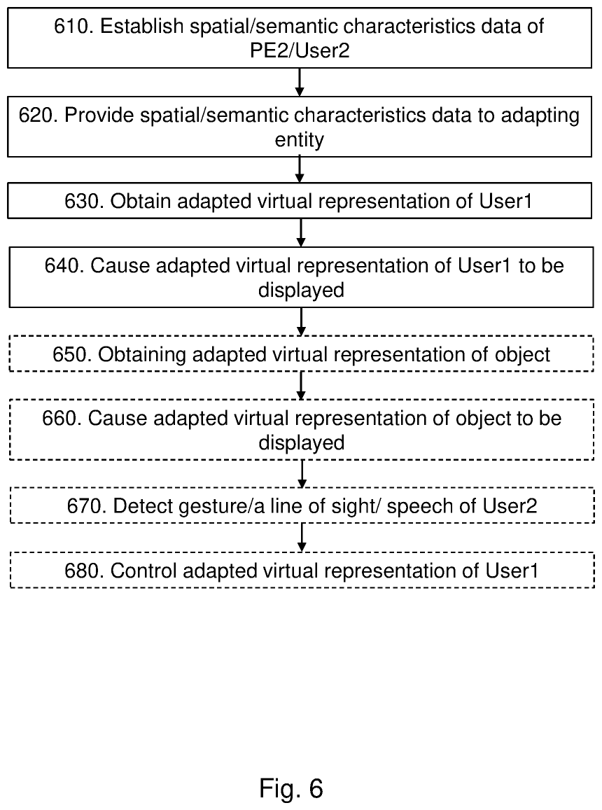

FIG. 6 shows a flow chart for a method performed in a second communication device 120 for adaptation between different environments in AR/MR communication in the AR/MR system 100. The AR/MR system 100 comprises at least two, a first and the second communication devices 110, 120. The first and second communication devices 110, 120 are in their respective physical environments PE1, PE2 and are associated with their respective users, User1, User2. The method comprises the following actions.

### Action 610

The second communication device 120 establishes spatial and semantic characteristics data of the physical environment and the user of the second communication device 120.

Environment-facing cameras in an HMD can be used to capture the environment and detect the spatial and semantic characteristics of the local environment. The spatial and semantic characteristics data of the physical environment and user is for adapting the remote participant's virtual representation to fit the user's current local context.

### Action 620

The second communication device 120 provides the spatial and semantic characteristics data to the adapting entity 130 for adapting a virtual representation of the user of the first communication device 110 (VRU1) comprising information on gestures and/or facial expressions of the user of the first communication device 110 based on the spatial and semantic characteristics data of the physical environment and the user of the second communication device 120.

### Action 630

The second communication device 120 obtains from the adapting entity 130 an adapted virtual representation, Adapted VRU1, of a user of the first communication device 110.

### Action 640

The second communication device 120 causing the adapted virtual representation of the user of the first communication device 110 to be displayed in the physical environment of the second communication device using AR/MR technology.

To displaying the objects, the method may further comprise the following actions:

### Action 650

The second communication device 120 obtains from the adapting entity 130, an adapted virtual representation of one or more objects with which the user of the first communication device 110 is interacting. The adapted virtual representation of the object is generated by adapting a virtual representation of the object based on the spatial and semantic characteristics data of the physical environment and user of the second communication device 120.

### Action 660

The second communication device 120 causes the adapted virtual representation of the object to be displayed in the physical environment of the second communication device 120 using AR/MR technology.

It may happen that placing the virtual representation of a person and objects into the local environment in a natural way fails, or the choices performed by the system might not be suitable for the local user. For example, the system might have placed an avatar in an available seat next to you, but you would prefer to interact with the avatar as if it was in front of you even if there is no seat there. Or an object was placed in the table in front of you, but it “disturbs” you or blocks your view to other objects behind it. In which case the user should be able to have a natural control over the placement, size, orientation, etc. of avatars and rendered objects.

To allow the user to have a natural control over the virtual representation of the person and objects in his environment, capturing gestures and analyzing gestures to affect the virtual representation's motion, path plan, placement etc., are needed. The method may further comprise the following actions:

### Action 670

The second communication device 120 detects any one of a gesture, a line of sight, or a speech of the user, User2, of the second communication device 120.

To interact with the virtual representations of a person and object, specific gesture patterns can be used much like when interacting with a touchscreen. The embodiments herein enable detecting when a user interact with a virtual representation, e.g., by moving the virtual representation by grabbing the virtual representation's arm or waving the hand the virtual representation will move etc., by detecting a grabbing gesture at the location of the arm or detecting a waving gesture. The embodiments herein also enable detecting a user interacting with the physical environment, e.g. when a user looking at a physical object and stretching for it by gaze or a line of sight detection. Theses can be done since all gestures and line of sight can be tracked using face-facing and environment-facing camera sensors. Other interaction methods that may be used involve select and confirm, voice commands etc.

### Action 680

The second communication device 120 may control the adapted virtual representation of the user of the first communication device 110 and/or the adapted virtual representation of the object with which the user of the first communication device 110 is interacting, based on any one of the detected gestures, line of sight, or speech.

The second communication device 120 may control the path of the adapted virtual representation. For example, if the user of the second communication device 120 grabs the arm of the adapted virtual representation and push the arm to the left, the adapted virtual representation is adjusted to move to the left. If a hand waving gesture sideways in the line of sight and the adapted virtual representation is in the line of sight, the adapted virtual representations path is adjusted to leave the line of sight e.g. to the left or right.

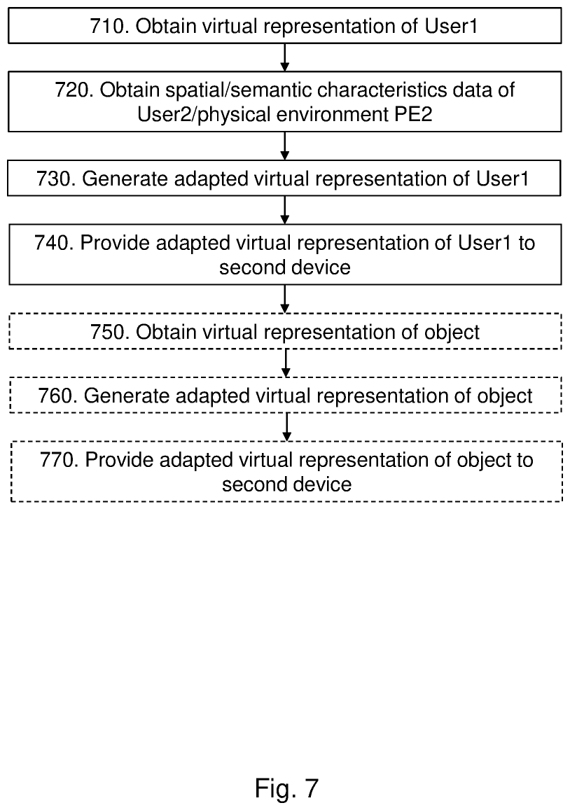

FIG. 7 shows a flow chart for a method performed in the adapting entity 130 for adaptation between different environments in AR/MR communication in the AR/MR system 100. The AR/MR system 100 comprises at least two, a first and a second communication devices 110, 120. The first and second communication devices 110, 120 are in their respective physical environments PE1, PE2 and are associated with their respective users, User1, User2. The method comprises the following actions.

### Action 710

The adapting entity 130 obtains a virtual representation of the user, VRU1, of the first communication device 110. The virtual representation VRU1 comprises information on gestures and/or facial expressions of the user of the first communication device 110.

According to some embodiments herein, the adapting entity 130 may obtain the virtual representation of the user of the first communication device from the first communication device 110. That is the first communication device 110 generate or create the virtual representation of the user of the first communication device 110 and provides it to the adapting entity 130.

According to some embodiments herein, the adapting entity 130 may obtain a model representing the user of the first communication device (110) and obtain gestures data and/or facial expressions data of the user of the first communication device from the first communication device 110 and then generate the virtual representation of the user of the first communication device (110) based on the model representing the user of the first communication (110) and the gestures data and/or facial expressions data of the user of the first communication device (110).

### Action 720

The adapting entity 130 obtains spatial and semantic characteristics data of the physical environment and user of the second communication device 120 from the second communication device 120.

### Action 730

The adapting entity 130 generates an adapted virtual representation of the user of the first communication device 110 by adapting the virtual representation of the user of the first communication device 110 based on the spatial and semantic characteristics data of the physical environment and user of the second communication device 120.

According to some embodiments herein, the adapting entity 130 generates an adapted virtual representation of the user of the first communication device 110 by creating a motion model for the virtual representation of the user of the first communication device based on movement data of the user of the second communication device and combining the motion model and the virtual representation of the user of the first communication device.

### Action 740

The adapting entity 130 provides the adapted virtual representation to the second communication device 120 for displaying in the physical environment of the second communication device 120 using AR/MR technology.

To bring one or more objects from one participant's environment to other participant's environment as virtual representations, the method may further comprise the following Actions:

### Action 750

The adapting entity 130 obtains a virtual representation of one or more objects, with which the user of the first communication device is interacting in its physical environment.

According to some embodiments herein, the adapting entity 130 may obtain the virtual representation of the object from the first communication device 110. That is the first communication device 110 generates the virtual representation of one or more objects and provides to the adapting entity 130.

According to some embodiments herein, the adapting entity 130 may obtain information on one or more objects with which the user of the first communication device is interacting in its physical environment from the first communication device and generates a virtual representation of the object based on the information on one or more objects with which the user of the first communication device is interacting.

### Action 760

The adapting entity 130 generates an adapted virtual representation of the object by adapting the virtual representation of the object based on the spatial and semantic characteristics data of the physical environment of the second communication device 120.

### Action 770

The adapting entity 130 provides the adapted virtual representation of the object to the second communication device 120 for displaying in the physical environment of the second communication device 120 using AR/MR technology.

Method actions described above with respect to the first and second communication devices 110, 120 and the adapting entity 130 for AR/MR communication in the AR/MR system 100 according to embodiments herein may be distributed differently between the AR/MR devices and the cloud 150 or the server 160, the network node 140 depending on processing requirements of each actions and processing capability of the AR/MR devices. For example, the heavy processing for generation and adaption of the virtual representation of person and object may be done in the cloud 150/server 160/network node 140, and the AR/MR devices may only capture gestures, video, get 3D models and textures or video and transmit or provide information on the gestures, video, get 3D models and textures or video etc. to the cloud 150/server 160/network node 140.

Embodiments herein enable real-time serializing and transferring the virtual representation of person/object model and texture from one user environment to the other's. A cloud resource may be in use to receive information on captured camera video, motion sensors, audio etc. and transform and adapt that into above mentioned virtual representations or avatars and objects.

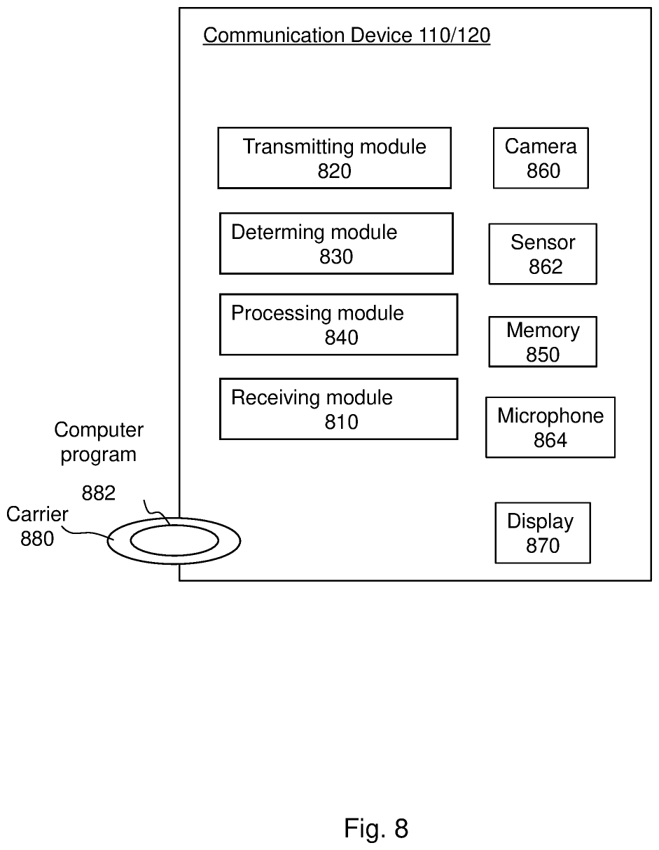

To perform the method in the first/second communication device 110/120 for adaptation between different environments in AR/MR communication in the AR/MR system 100, the first/second communication device 110/120 comprises modules or units as shown in FIG. 8. The first/second communication device 110/120 comprises a receiving module 810, a transmitting module 820, a determining module 830, a processing module 840, a memory 850, a camera module 860, a sensor module 862, a microphone module 864, a display module 870 etc.

The first communication device 110 is configured to perform any one of the method actions 510-580 described above.

The first communication device 110 is configured to, by means of e.g. the determining module 830, the processing module 840 being configured to, obtain a model representing a user, User1, of the first communication device 110.

The first communication device 110 is configured to, by means of e.g. the determining module 830, the camera module 860, the sensor module 870 being configured to, establish gestures data and/or facial expressions data of the user, User1, of the first communication device 110.

The first communication device 110 is configured to, by means of e.g. the processing module 840 being configured to, generate a virtual representation of the user, User1, of the first communication device 110 based on the model and the gestures and/or facial expressions data of the user of the first communication device 110.

The first communication device 110 is configured to, by means of e.g. the transmitting module 820 being configured to, provide the virtual representation of the user of the first communication device to the adapting entity 130 for adapting the virtual representation of the user of the first communication device based on spatial and semantic characteristics data of the physical environment, PE2, and user, User2, of the second communication device 120.

The first communication device 110 may be further configured to, by means of e.g. the determining module 830, the camera module 860, the sensor module 870 being configured to, detect one or more objects with which the user of the first communication device 110 is interacting in its physical environment based on any one or a combination of gesture tracking, image object detection, the user's and/or other's speech.

The second communication device 120 is configured to perform any one of the method actions 610-680 described above.

The second communication device 120 is configured to, by means of e.g. the determining module 830, the camera module 860, the sensor module 870 being configured to, establish spatial and semantic characteristics data of the physical environment and user of the second communication device.

The second communication device 120 is configured to, by means of e.g. the transmitting module 820 being configured to, provide the spatial and semantic characteristics data to an adapting entity for adapting a virtual representation of the user of the first communication device based on the spatial and semantic characteristics data of the physical environment and user of the second communication device. The virtual representation comprises information on gestures and/or facial expressions of the user of the first communication device.

The second communication device 120 is configured to, by means of e.g. the receiving module 810 being configured to, obtain from the adapting entity an adapted virtual representation of a user of the first communication device.

The second communication device 120 is configured to, by means of e.g. the display module 870, causes the adapted virtual representation of the user of the first communication device to be displayed in the physical environment of the second communication device using AR/MR technology.

Those skilled in the art will appreciate that the receiving module 810, the transmitting module 820, the determining module 830 and the processing module 840 described above in the first/second communication device 110/120 may be referred to one circuit or unit, a combination of analog and digital circuits, one or more processors, configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The method according to embodiments herein may be implemented through one or more processors in the first/second communication device 110/120 together with computer program code for performing the functions and actions of the embodiments herein. The program code mentioned above may also be provided as a computer program product, for instance in the form of a data carrier 880 carrying computer program code 882, as shown in FIG. 8, for performing the embodiments herein when being loaded into the first/second communication device 110/120. One such carrier is shown as the form of a CD ROM disc. It is however feasible with other data carriers such as a memory stick. The computer program code may furthermore be provided as pure program code on a server or a cloud and downloaded to the first/second communication device 110/120.

The memory 850 in the first/second communication device 110/120 may comprise one or more memory units and may be arranged to be used to store received information, measurements, data, configurations and applications to perform the method herein when being executed in the first/second communication device 110/120.

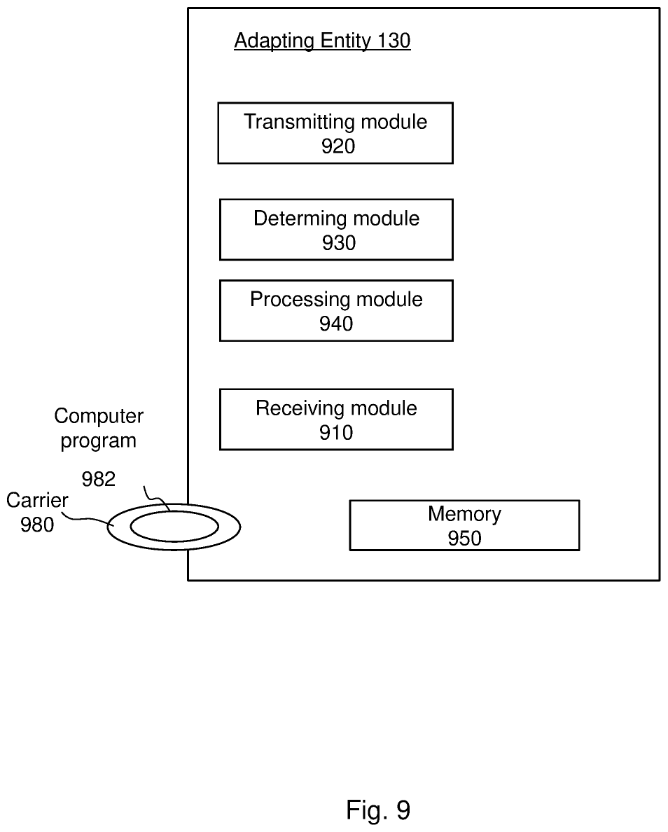

To perform the method in the adapting entity 130 for adaptation between different environments in AR/MR communication in the AR/MR system 100, the adapting entity 130 comprises modules or units as shown in FIG. 9. The adapting entity 130 comprises a receiving module 910, a transmitting module 920, a determining module 930, a processing module 940, a memory 950 etc. The adapting entity 130 is configured to perform any one of the method actions 710-770 described above.

The adapting entity 130 is configured to, by means of e.g. the receiving module 910 being configured to, obtain a virtual representation of the user of the first communication device 110. The virtual representation comprises information on gestures and/or facial expressions of the user of the first communication device 110.

The adapting entity is configured to, by means of e.g. the receiving module 910 being configured to, obtain spatial and semantic characteristics data of the physical environment and user of the second communication device 120 from the second communication device 120.

The adapting entity is configured to, by means of e.g. the determining module 910, the processing module 940 being configured to, generate an adapted virtual representation of the user of the first communication device 110 by adapting the virtual representation of the user of the first communication device 110 based on the spatial and semantic characteristics data of the physical environment and user of the second communication device 120.

The adapting entity is configured to, by means of e.g. the transmitting module 920 being configured to provides the adapted virtual representation to the second communication device 120 for displaying in the physical environment of the second communication device 120 using AR/MR technology.

Those skilled in the art will appreciate that the receiving module 910, the transmitting module 920, the determining module 930 and the processing module 940 described above in the adapting entity 130 may be referred to one circuit or unit, a combination of analog and digital circuits, one or more processors, configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC).

The method according to embodiments herein may be implemented through one or more processors in the adapting entity 130 together with computer program code for performing the functions and actions of the embodiments herein. The program code mentioned above may also be provided as a computer program product, for instance in the form of a data carrier 980 carrying computer program code 982, as shown in FIG. 9, for performing the embodiments herein when being loaded into the adapting entity 130. One such carrier is shown as the form of a CD ROM disc. It is however feasible with other data carriers such as a memory stick. The computer program code may furthermore be provided as pure program code and downloaded to the adapting entity 130.

The memory 950 in the adapting entity 130 may comprise one or more memory units and may be arranged to be used to store received information, data, configurations and applications to perform the method herein when being executed in the adapting entity 130.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1. A method performed in an adapting entity, for adaptation between different environments in Augmented Reality or Mixed Reality, AR/MR communication in an AR/MR system, the AR/MR system comprising at least, a first communication device and a second communication device, the first and second communication devices being in their respective physical environments being are associated with their respective users, the method comprising:
obtaining a virtual representation of the user of the first communication device, the virtual representation comprising information on one or both of gestures and facial expressions of the user of the first communication device;
obtaining spatial and semantic characteristics data of the physical environment and user of the second communication device from the second communication device;
generating an adapted virtual representation of the user of the first communication device by adapting the virtual representation of the user of the first communication device based on the spatial and semantic characteristics data of the physical environment and user of the second communication device; and
providing the adapted virtual representation to the second communication device for displaying in the physical environment of the second communication device using AR/MR technology.

2. The method according to claim 1, wherein obtaining the virtual representation of the user of the first communication device comprises:
obtaining the virtual representation of the user of the first communication device from the first communication device or obtaining a model representing the user of the first communication device;
obtaining one or both of gestures data and facial expressions data of the user of the first communication device from the first communication device; and
generating the virtual representation of the user of the first communication device based on the model representing the user of the first communication device and one or both of the gestures data and facial expressions data of the user of the first communication device.

3. The method according to claim 1, wherein generating an adapted virtual representation of the user of the first communication device comprises:
creating a motion model for the virtual representation of the user of the first communication device based on movement data of the user of the second communication device; and
combining the motion model and the virtual representation of the user of the first communication device to generate the adapted virtual representation of the user of the first communication device.

4. The method according to claim 1, further comprising:
obtaining a virtual representation of one or more objects, with which the user of the first communication device is interacting in its physical environment;
generating an adapted virtual representation of the object by adapting the virtual representation of the object based on the spatial and semantic characteristics data of the physical environment of the second communication device; and
providing the adapted virtual representation of the object to the second communication device for displaying in the physical environment of the second communication device using AR/MR technology.

5. The method according to claim 4, wherein obtaining the virtual representation of one or more objects comprises:
obtaining the virtual representation of the object from the first communication device or obtaining information on one or more objects with which the user of the first communication device is interacting in its physical environment from the first communication device; and
generating a virtual representation of the object based on the information on one or more objects with which the user of the first communication device is interacting.

6. A method performed in a first communication device for adaptation between different environments in Augmented Reality or Mixed Reality, AR/MR communication in an AR/MR system, wherein the AR/MR system comprising at least, the first communication device and a second communication, the first and second communication devices being in their respective physical environments and being associated with their respective users, the method comprising:
obtaining a model representing a user of the first communication device;
establishing one or both of gestures data and/of and facial expressions data of the user of the first communication device;
generating a virtual representation of the user of the first communication device based on the model and the one or both of the gestures and facial expressions data of the user of the first communication device; and
providing the virtual representation of the user of the first communication device to an adapting entity for adapting the virtual representation of the user of the first communication device based on spatial and semantic characteristics data of the physical environment and user of the second communication device.

7. The method according to claim 6, further comprising:
detecting one or more objects with which the user of the first communication device is interacting in its physical environment based on any one or a combination of gesture tracking, image object detection, the user's and other's speech; and
providing information on the detected one or more objects to the adapting entity for generating a virtual representation of the one or more objects and adapting the virtual representation of the object based on spatial and semantic characteristics data of the physical environment and user of the second communication device.

8. The method according to claim 6, further comprising:
detecting one or more objects with which the user of the first communication device is interacting in its physical environment based on any one or a combination of gesture tracking, image object detection, the user's and other's speech;
generating a virtual representation for the object with which the user of the first communication device is interacting; and
providing the virtual representation of the object to the adapting entity for adapting the virtual representation of object based on spatial and semantic characteristics data of the physical environment and user of the second communication device.

9. The method according to claim 6, wherein generating a virtual representation for one or more objects with which the user of the first communication device is interacting comprises any one of:
using available models for the recognized objects;
generating 3D or 2D models for the objects using point cloud reconstructions;
combining available models with point cloud reconstructions.

10.-13. (canceled)

14. An adapting entity for adaptation between different environments in Augmented Reality or Mixed Reality, AR/MR, communication in an AR/MR system, the AR/MR system comprising at least, a first communication device and a second communication device, the first and second communication devices are being in their respective physical environments and being associated with their respective users, the adapting entity being configured to:
obtain a virtual representation of the user of the first communication device, the virtual representation comprising information on one or both of gestures and facial expressions of the user of the first communication device;
obtain spatial and semantic characteristics data of the physical environment and user of the second communication device from the second communication device;
generate an adapted virtual representation of the user of the first communication device by adapting the virtual representation of the user of the first communication device based on the spatial and semantic characteristics data of the physical environment and user of the second communication device; and
provide the adapted virtual representation to the second communication device for displaying in the physical environment of the second communication device using AR/MR technology.

15. A first communication device for adaptation between different environments in Augmented Reality or Mixed Reality, AR/MR, communication in an AR/MR system, the AR/MR system comprising at least a first communication device and a second communication device, the first and second communication devices being in their respective physical environments and being associated with their respective users, the first communication device being configured to:
obtain a model representing a user of the first communication device;
establish one or both of gestures data and facial expressions data of the user of the first communication device;
generate a virtual representation of the user of the first communication device based on the model and the one or both of the gestures and facial expressions data of the user of the first communication device; and
provide the virtual representation of the user of the first communication device to an adapting entity for adapting the virtual representation of the user of the first communication device based on spatial and semantic characteristics data of the physical environment and user of the second communication device.

16. (canceled)

17. The adapting entity according to claim 14, wherein obtaining the virtual representation of the user of the first communication device comprises:
obtaining the virtual representation of the user of the first communication device from the first communication device or obtaining a model representing the user of the first communication device;
obtaining one or both of gestures data and facial expressions data of the user of the first communication device from the first communication device; and
generating the virtual representation of the user of the first communication device based on the model representing the user of the first communication device and one or both of the gestures data and facial expressions data of the user of the first communication device.

18. The adapting entity according to claim 14, wherein generating an adapted virtual representation of the user of the first communication device comprises:
creating a motion model for the virtual representation of the user of the first communication device based on movement data of the use of the second communication device; and
combining the motion model and the virtual representation of the user of the first communication device to generate the adapted virtual representation of the user of the first communication device.

19. The adapting entity according to claim 14, wherein the adapting entity is further configured to:
obtain a virtual representation of one or more objects, with which the user of the first communication device is interacting in its physical environment;
generate an adapted virtual representation of the object by adapting the virtual representation of the object based on the spatial and semantic characteristics data of the physical environment of the second communication device; and
provide the adapted virtual representation of the object to the second communication device for displaying in the physical environment of the second communication device using AR/MR technology.

20. The adapting entity according to claim 19, wherein obtaining the virtual representation of one or more objects comprises:
obtaining the virtual representation of the object from the first communication device or obtaining information on one or more objects with which the user of the first communication device is interacting in its physical environment from the first communication device; and
generating a virtual representation of the object based on the information on one or more objects with which the user of the first communication device is interacting.

21. The first communication entity according to claim 15, wherein the first communication entity is further configured to:
detect one or more objects with which the user of the first communication device is interacting in its physical environment based on any one or a combination of gesture tracking, image object detection, the user's and other's speech; and
providing information on the detected one or more objects to the adapting entity for generating a virtual representation of the one or more objects and adapting the virtual representation of the object based on spatial and semantic characteristics data of the physical environment and user of the second communication device.

22. The first communication entity according to claim 15, wherein the first communication entity is further configured to:
detect one or more objects with which the user of the first communication device is interacting in its physical environment based on any one or a combination of gesture tracking, image object detection, the user's and other's speech;
generating a virtual representation for the object with which the user of the first communication device is interacting; and
providing the virtual representation of the object to the adapting entity for adapting the virtual representation of object based on spatial and semantic characteristics data of the physical environment and user of the second communication device.

23. The first communication entity according to claim 15, wherein generating a virtual representation for one or more objects with which the use of the first communication device is interacting comprises any one of:
using available models for the recognized objects;
generating 3D or 2D models for the objects using point cloud reconstructions;
combining available models with point cloud reconstructions.
